(19) United States
(12) Patent Application Publication
(10) Pub. No.: US 2026/0211081 A1
(43) Pub. Date: Jul. 23, 2026

(54) RADAR SYSTEM AND METHOD FOR ADJUSTING A WAVEFORM TO IMPROVE SIGNAL RESOLUTION

(71) Applicant: National Yunlin University of Science and Technology, Douliou City (TW)

(72) Inventors: Tai-Hsing LEE, Douliou City (TW); Yu-Tai OU, Douliou City (TW)

(21) Appl. No.: 19/454,800

(22) Filed: Jan. 21, 2026

(30) Foreign Application Priority Data
Jan. 22, 2025 (TW) 114102876

(51) Int. Cl. G01S 7/41; G01S 7/03

(52) U.S. Cl. CPC G01S 7/418; G01S 7/03

(57) ABSTRACT

A radar system includes a receiver that receives a received signal and a processing unit. The received signal that includes a waveform, the waveform including a plurality of successive wave points, each of the wave points indicating an intensity on a specific time instance. The processing unit is connected to the receiver and implements a procedure to process the waveform so as to generate an adjusted waveform. The procedure includes identifying, from the wave points included in the waveform, a critical point; recording an intensity of the critical point, and setting the intensity of the critical point as a local high intensity; and adjusting the intensity of each of the wave points that is not the critical point, so as to generate an adjusted waveform of the received signal.

### CROSS-REFERENCE TO RELATED APPLICATION

This application claims priority to Taiwanese Invention Patent Application No. 114102876, filed on Jan. 22, 2025, the entire disclosure of which is incorporated by reference herein.

### FIELD

The disclosure relates to a method for adjusting a waveform, and more particularly to a method for adjusting a waveform included in a received signal, in order to improve signal resolution, and a radar system that is configured to implement the method.

### BACKGROUND

In the field of radio detection and ranging (RADAR), in order to detect an object and determine a distance to the object, a transmitter (Tx) of a radar system is configured to transmit a signal wave, which is typically in the form of a sinusoid wave. When the signal wave propagates and comes in contact with the object, the signal wave is reflected by the object as an echo signal, the echo signal propagates back to a receiver (Rx) of the radar system. The receiver is configured to receive the echo signal in order to determine the distance between the object and the radar system.

Typically, a wavelength of the signal wave affects the distance which the wave signal can travel. However, in the case of a longer wavelength, when multiple echo signals reflected by multiple objects are simultaneously received, due to the wavelength being longer, the multiple echo signals may overlap one another in the time domain, which may decrease the resolution with respect to the time domain, thereby causing the radar system to be unable to distinguish between the objects.

It is also noted that conventionally, decreasing the wavelength of the signal wave may be beneficial to cure the above deficiency. However, the shorter the wavelength, the shorter the distance over which the wave signal can travel.

### SUMMARY

Therefore, one object of the disclosure is to provide a radar system that can alleviate at least one of the drawbacks of the prior art.

According to one embodiment of the disclosure, the radar system includes a receiver and a processing unit connected to the receiver. The receiver receives a received signal that includes an original waveform. The original waveform includes a plurality of discrete wave points that correspond respectively to successive time instances. Each of the wave points indicates an intensity on a specific time instance. The processing unit is configured to implement a procedure to process the original waveform so as to generate an adjusted waveform. The procedure includes, for each of the wave points,
determining whether the wave point is a critical point;
in response to determining that the wave point is a critical point, recording an intensity of the critical point, and setting the intensity of the critical point as a local high intensity; and
in response to determining that the wave point is not a critical point, adjusting the intensity of the wave point.

Another object of the disclosure is to provide a method implemented by the above-mentioned radar system.

According to one embodiment of the disclosure, the method for adjusting a waveform is implemented using a system that includes a receiver and a processing unit connected to the receiver, the method includes:
receiving, by the receiver, a received signal that includes an original waveform, the original waveform including a plurality of discrete wave points that correspond respectively to successive time instances, each of the wave points indicating an intensity on a specific time instance; and
implementing, by the processing unit, a procedure to process the original waveform so as to generate an adjusted waveform, the procedure including, for each of the wave points,
determining whether the wave point is a critical point;
in response to determining that the wave point is a critical point, recording an intensity of the critical point, and setting the intensity of the critical point as a local high intensity; and
in response to determining that the wave point is not a critical point, adjusting the intensity of the wave point.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating components of a radar system 100 according to one embodiment of the disclosure.

FIG. 2 is a flow chart illustrating a method for adjusting a waveform included in a received signal, in order to improve a signal resolution according to one embodiment of the disclosure.

FIG. 3 illustrates a typical waveform of a received signal and an exemplary adjusted waveform.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

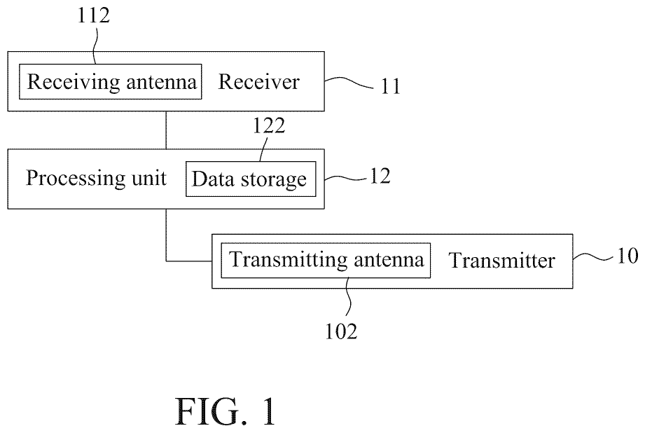

FIG. 1 is a block diagram illustrating components of a radar system 100 according to one embodiment of the disclosure. In this embodiment, the radar system 100 includes a transmitter 10, a receiver 11 and a processing unit 12.

The processing unit 12 is connected to the transmitter 10 and the receiver 11, and may be embodied using a central processing unit (CPU), a microprocessor, a microcontroller, a single core processor, a multi-core processor, a dual-core mobile processor, a digital signal processor (DSP), a field-programmable gate array (FPGA), an application specific integrated circuit (ASIC), and/or a radio-frequency integrated circuit (RFIC), etc. The processing unit 12 may include a non-transitory data storage unit 122 (e.g., a flash memory) which stores instructions that, when executed by the processing unit, cause the processing unit 12 to perform the operations as described below.

The transmitter 10 may be an electronic device that include a transmitting antenna 102 for generating a radio wave. For example, the transmitter 10 may include circuitry for generating a radio frequency alternative current that is to be applied to the transmitting antenna 102. In response to receipt of the radio frequency alternative current, the transmitting antenna 102 is configured to radiate a radio wave accordingly.

The receiver 11 may be an electronic device that include a receiving antenna 112 for receiving a radio wave. Typically, the receiving antenna 112 may include circuitry that, in response to receiving a radio wave, converts the received radio wave into an alternating current. Then, the receiver 11 transmits the alternating current to the processing unit 12 for subsequent data processing; that is, the processing unit 12 can obtain data representing a waveform of the radio wave based on the alternating current.

In use, after the transmitting antenna 102 of the transmitter 10 is configured to radiate a radio wave. After the radio wave travels and encounters an object, the radio wave is reflected by the object as an echo wave that travels back to the radar system 100. Then, the receiving antenna 112 of the receiver 11 receives the echo wave and converts the echo wave into an alternating current, and the receiver 11 transmits the alternating current representing the echo wave to the processing unit 12; then, the processing unit 12 obtains data representing a waveform of the echo wave based on the alternating current.

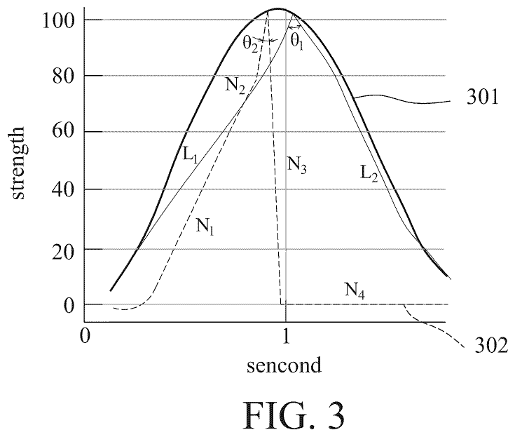

In use, in response to the echo wave from the receiver 11, the processing unit 12 is configured to implement a method for adjusting a waveform of the echo wave, so as to generate an adjusted waveform. FIG. 3 illustrates a typical waveform 301 of the echo wave and an exemplary adjusted waveform 302. Generally, the waveform is represented using a plurality of discrete wave points that correspond respectively to successive time instances, and each of the wave points indicates an intensity (on an Y axis) of the echo wave on a specific time instance (on an X axis). In some embodiments, the waveform 301 of the echo wave may include, for example, 30 to 60 wave points per second.

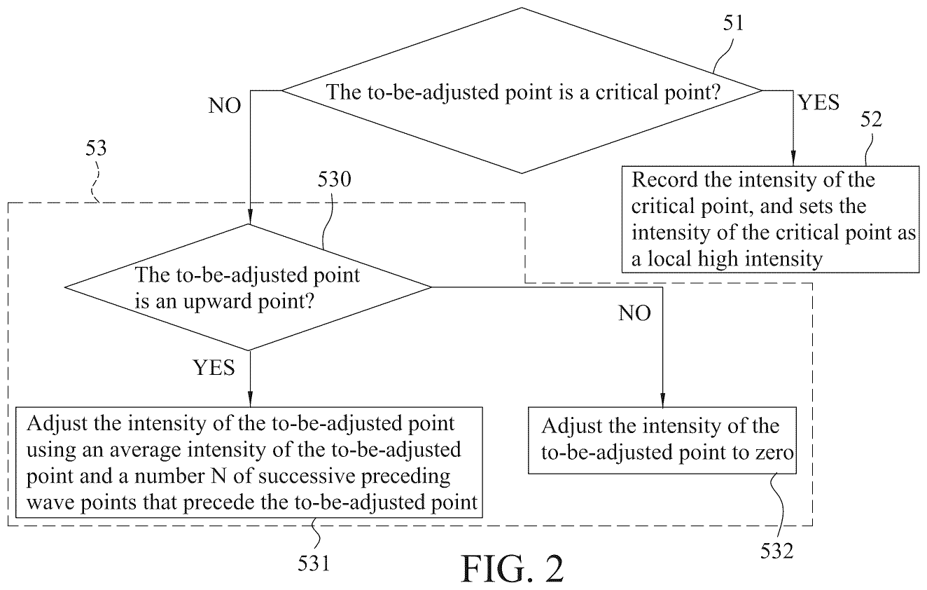

FIG. 2 is a flow chart illustrating a method for adjusting a waveform of a received signal, in order to improve a signal resolution according to one embodiment of the disclosure. In the embodiment of FIG. 2, the method is implemented using the radar system 100 as shown in FIG. 1, but it is not limited to such.

In step 50, the receiver 11 receives a received signal with a waveform (original waveform). For example, the received signal may be an echo wave, and may have a waveform 301 (i.e., the original waveform) as shown in FIG. 3. It is noted that in other embodiments, different forms of received signal may be employed. Subsequently, the processing unit 12 executes steps 51-53 for each of the wave points of the waveform 301 of the echo wave (hereinafter referred to as “to-be-adjusted point”).

In step 51, the processing unit 12 determines whether the to-be-adjusted point is a critical point. That is to say, a critical point is identified from among the wave points of the waveform 301 of the echo wave. In response to determining that the to-be-adjusted point is the critical point, the flow proceeds to step 52. Otherwise, in the case that the to-be-adjusted point is not the critical point, the flow proceeds to step 53.

Specifically, in some embodiments, the critical point may be defined as a top point of the wave form 301, or one of the wave points that is immediately preceding or immediately succeeding the top point, where the top point is one of the wave points that has a highest intensity (i.e., at a top position on the Y axis of the chart of FIG. 3). In the example shown in FIG. 3, the wave point that is immediately preceding the top point is categorized as the critical point. It is noted that in other embodiments, different wave points may also be categorized as the critical point based on different applications, and is not limited to what has been described above. It is noted that in some embodiments, a first one and a last one of the wave points of the waveform 301 of the echo wave (i.e., the starting point and the end point) may be ignored.

In some embodiments, other manners for determining whether the to-be-adjusted point is the critical point may be employed. For example, the processing unit 12 determines whether the to-be-adjusted point is the critical point based on a first succeeding wave point that refers to one of the wave points immediately following the to-be-adjusted point, and a second succeeding wave point that refers to another one of the wave points immediately following the first succeeding wave point. Specifically, the processing unit 12 determines the to-be-adjusted point as the critical point in a case that the first succeeding wave point has an intensity higher than the intensity of the to-be-adjusted point, and the second succeeding wave point has an intensity lower than the intensity of the first succeeding wave point. In such a case, the first succeeding wave point of the critical point is the top point.

In another example, the processing unit 12 determines whether the to-be-adjusted point is the critical point based on the first succeeding wave point immediately following the to-be-adjusted point, and a first preceding wave point that refers to another one of the wave points immediately preceding the to-be-adjusted point. Specifically, the processing unit 12 determines the to-be-adjusted point as the critical point in a case that the first succeeding wave point has an intensity lower than the intensity of the to-be-adjusted point, and the first preceding wave point has an intensity lower than the intensity of the to-be-adjusted point. In such a case, the critical point is the top point.

In yet another example, the processing unit 12 determines whether the to-be-adjusted point is the critical point based on the first preceding wave point immediately preceding the to-be-adjusted point, and a second preceding wave point that refers to another one of the wave points immediately preceding the first preceding wave. Specifically, the processing unit 12 determines the to-be-adjusted point as the critical point in a case that the first preceding wave point has an intensity higher than the intensity of the to-be-adjusted point, and the second preceding wave point has an intensity lower than the intensity of the first preceding wave point. In such a case, the first preceding wave point of the critical point is the top point. It is noted that the embodiment of FIG. 3 employs this manner to categorize the wave points.

It is defined that a part of the waveform 301 from a starting point of the waveform 301 to the critical point as a rising part, and another part of the waveform 301 from the critical point to an end point of the waveform 301 as a falling part. A first angle θ₁ is defined as an angle between a first line L₁ connecting the starting point and the critical point and a second line L₂ connecting the critical point and the end point. In step 52, the processing unit 12 records the intensity of the critical point, and

sets the intensity of the critical point as a local high intensity. That is to say, the waveform 301 of the echo wave is adjusted in a manner that the intensity of the critical point is the highest of an adjusted waveform after the adjustment.

In step 53, the processing unit 12 adjusts the intensity of the to-be-adjusted point that is not the critical point, so as to generate an adjusted waveform 302. It is noted that for each of the wave points that is not the critical point, the intensity of the wave point is adjusted to be lower than the local high intensity. Specifically, step 53 includes sub-steps 530-532.

In sub-step 530, the processing unit 12 further determines whether the to-be-adjusted point is an upward point. In response to determining that the to-be-adjusted point is an upward point (e.g., the determination is affirmative), the flow proceeds to sub-step 531. Otherwise, in the case that the to-be-adjusted point is not an upward point (i.e., the to-be-adjusted point is a downward point), the flow proceeds to sub-step 532.

Specifically, in some embodiments, the upward point is defined as a wave point with an immediately preceding wave point that immediately precedes the wave point on the time domain and that has an intensity lower than an intensity of the wave point, and with an immediately succeeding wave point that immediately follows the wave point on the time domain and that has an intensity higher than the intensity of the wave point. This indicates that on the chart of FIG. 3, the upward point is in a section of the waveform 301 that is “rising” as the time progresses (i.e., the rising part). This indicates that on the chart of FIG. 3, the top point has the highest intensity (i.e., at a top position on the Y axis of the chart of FIG. 3). The downward point is defined as a wave point with an immediately preceding wave point that immediately precedes the wave point on the time domain and that has an intensity higher than the intensity of the wave point, and with an immediately succeeding wave point that immediately follows the wave point on the time domain and that has an intensity lower than the intensity of the wave point. This indicates that on the chart of FIG. 3, the downward point is in a section of the waveform 301 that is “falling” as the time progresses (i.e., the falling part).

In some embodiments, other manners for determining whether the to-be-adjusted point is the upward point may be employed. For example, the processing unit 12 determines whether the to-be-adjusted point is the upward point based on whether the first succeeding wave point immediately follows the to-be-adjusted point, and whether the second succeeding wave point immediately follows the first succeeding wave point. Specifically, the processing unit 12 determines the to-be-adjusted point as an upward point in a case that the first succeeding wave point has an intensity higher than the intensity of the to-be-adjusted point, and the second succeeding wave point has an intensity higher than the intensity of the first succeeding wave point. On the other hand, the processing unit 12 determines the to-be-adjusted point as a downward point in a case that the first succeeding wave point has an intensity lower than the intensity of the to-be-adjusted point, and the second succeeding wave point has an intensity lower than the intensity of the first succeeding wave point. In such a case, the first succeeding wave point of the critical point is the top point.

In another example, the processing unit 12 determines whether the to-be-adjusted point is the upward point based on whether the first succeeding wave point immediately follows the to-be-adjusted point, and whether the first preceding wave point immediately precedes the to-be-adjusted point. Specifically, the processing unit 12 determines the to-be-adjusted point as an upward point in a case that the first succeeding wave point has an intensity higher than the intensity of the to-be-adjusted point, and the first preceding wave point has an intensity lower than the intensity of the to-be-adjusted point. On the other hand, the processing unit 12 determines the to-be-adjusted point as a downward point in a case that the first succeeding wave point has an intensity lower than the intensity of the determines the to-be-adjusted point, and the first preceding wave point has an intensity higher than the intensity of the determines the to-be-adjusted point. In such a case, the critical point is the top point.

In yet another example, the processing unit 12 determines whether the to-be-adjusted point is the upward point based on whether the first preceding wave point immediately precedes the to-be-adjusted point, and whether the second preceding wave point immediately precedes the first preceding wave. Specifically, the processing unit 12 determines the to-be-adjusted point as an upward point in a case that the first preceding wave point has an intensity lower than the intensity of the to-be-adjusted point, and the second preceding wave point has an intensity lower than the intensity of the first succeeding wave point. On the other hand, the processing unit 12 determines the to-be-adjusted point as a downward point in a case that the first preceding wave point has an intensity higher than the intensity of the to-be-adjusted point, and the second preceding wave point has an intensity higher than the intensity of the first succeeding wave point. It is noted that the embodiment of FIG. 3 employs this manner to categorize the wave points.

In sub-step 531, in the case that the to-be-adjusted point is an upward point, the processing unit 12 adjust the intensity of the to-be-adjusted point using an average intensity of the to-be-adjusted point and a number N of successive preceding wave points that precede the to-be-adjusted point. In this embodiment, the number N equals to 3. However, in different embodiments, the number N may be in the range of about 1 to about 1000. This results in a first part of the adjusted waveform 302 that, on FIG. 3, looks shrunken compared with the rising part of the waveform 301. Specifically, the first part of the adjusted waveform 302 includes a first segment N₁ that rises relatively slowly and a second segment N₂ that rises more sharply.

On the other hand, in the case that the wave point is a downward point, the processing unit 12 adjusts the intensity of the to-be-adjusted point to zero in sub-step 532. As such, this results in the adjusted waveform 302 having a second part that rapidly drops to zero. Specifically, the second part of the adjusted waveform 302 includes a third segment N₃ that drops rapidly to zero and a fourth segment N₄ that is flat at zero.

Generally, the operations of step 53 results in an adjusted waveform 302 that includes a first part (including the first segment N₁ and the second segment N₂) and a second part (including the third segment N₃ and the fourth segment N₄) that converge at the critical point, and a second angle θ₂ between the second segment L₂ and the third segment L₃ is smaller than the first angle θ₁. Then, the adjusted waveform 302 may be stored in the data storage 122 or transmitted to a backend electronic device for further processing. In some embodiments, the method further includes a step of identifying, by the

radar system 100, one or more objects based on the adjusted waveform 302, and determining a distance between the radar system 100 and each of the objects.

In some embodiments, the receiver receives a plurality of received signals each including an original waveform. The processing unit 12, for each of the received signals, implements the procedure as described above to process the original waveform so as to generate a corresponding adjusted waveform. Then, the processing unit 12 further detects, based on the adjusted waveform for each of the received signals, an object, and determines a distance between the radar system and the object, resulting in a plurality of detected objects and a plurality of corresponding distances.

To sum up, the embodiments of the disclosure provides a method for adjusting an original waveform of a received signal, in order to improve a signal resolution. In the method, a waveform of the received signal is processed to categorize each of the wave points as one of a n upward point, a critical point and a downward point. Then, based on a result of the categorization, each of the wave points is adjusted so as to generate an adjusted waveform. It is noted that the adjusted waveform retains the characteristics of the original waveform (e.g., the critical point, the frequency, the wavelength, etc.) while significantly shrinking the size of the original waveform on a time/intensity chart. As such, in the case that multiple signals are received in a time period, the processing unit of the radar system may be able to clearly distinguish the signals from one another. That is to say, using the method as described above to process the received signals, the resolution of the received signal(s) with respect to the time domain is improved, allowing the radar system to be able to distinguish between the objects from the echo signals. Additionally, the above method may be implemented without having to manually adjust the wavelength or frequency of the radio wave emitted by the transmitter, and therefore is highly compatible with the existing radar systems.

Additionally, the method as described above may be particularly useful in the cases that: (1) two or more objects that are to be detected are in proximity; and (2) the radio wave transmitted by the transmitter 10 is relatively higher. Moreover, since the radio wave is in the form of an electromagnetic wave, other communication systems that employ electromagnetic wave to transmit data (e.g., Radar, light detection and ranging (LiDAR), household Wi-Fi, telecommunication base stations, low Earth orbit (LEO) satellites, communication systems using silicon photonics, etc.) may encounter similar case as mentioned above. In any case, after using the method as described above, an accurate distance between the radar system and each of the objects may be obtained, which may enable further applications to be implemented (such as, establishing a communication with each of the objects, transmitting different signals to each of the objects to interact with and/or control each of the objects, etc.) By implementing the method of this disclosure, the accuracy of clearly distinguishing two or more neighboring objects using high frequency waves can be significantly improved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A radar system comprising:
a receiver that receives a received signal that includes an original waveform, the original waveform including a plurality of discrete wave points that correspond respectively to successive time instances, each of the wave points indicating an intensity on a specific time instance; and
a processing unit connected to the receiver and configured to implement a procedure to process the original waveform so as to generate an adjusted waveform, the procedure including, for each of the wave points,
determining whether the wave point is a critical point;
in response to determining that the wave point is a critical point, recording an intensity of the critical point, and setting the intensity of the critical point as a local high intensity; and
in response to determining that the wave point is not a critical point, adjusting the intensity of the wave point.

2. The radar system as claimed in claim 1, the original waveform of the received signal further including a starting point and an end point, a first angle being defined by a first line defined by the starting point and the critical point, a second line defined by the critical point and the end point, and the critical point at which the first line and the second line converge, wherein:
the processing unit generates an adjusted waveform of the received signal to include a first part and a second part that converge at the critical point, and a second angle defined by the first part, the second part and the critical point is smaller than the first angle.

3. The radar system as claimed in claim 2, wherein the procedure further includes:
categorizing, for each of the wave points included in the original waveform excluding the critical point, the wave point into one of an upward point and a downward point.

4. The radar system as claimed in claim 3, wherein the processing unit adjusts the intensity of each of the wave points that is not the critical point by:
in the case that the wave point is an upward point, adjusting the wave point using an average intensity of the wave point and a plurality of preceding wave points; and
in the case that wave point is a downward point, adjusting the intensity of the wave point to zero.

5. The radar system as claimed in claim 3, wherein, for each of the wave points included in the original waveform:
the processing unit categorizes the wave point as an upward point in a case that a first succeeding wave point that is immediately succeeding the wave point has an intensity higher than the wave point, and a second succeeding wave point that is immediately succeeding the first succeeding wave point has an intensity higher than the first succeeding wave point;
the processing unit categorizes the wave point as a downward point in a case that a first succeeding wave point that is immediately succeeding the wave point has an intensity lower than the wave point, and a second succeeding wave point that is immediately succeeding the first succeeding wave point has an intensity lower than the first succeeding wave point; and
the processing unit identifies the wave point as the critical point in a case that a first succeeding wave point that is immediately succeeding the wave point has an intensity higher than the wave point, and a second succeeding wave point that is immediately succeeding the first succeeding wave point has an intensity lower than the first succeeding wave point.

6. The radar system as claimed in claim 3, wherein, for each of the wave points included in the original waveform:
the processing unit categorizes the wave point as an upward point in a case that a first succeeding wave point that is immediately succeeding the wave point has an intensity higher than the wave point, and a first preceding wave point that is immediately preceding the wave point has an intensity lower than the wave point;
the processing unit categorizes the wave point as a downward point in a case that a first succeeding wave point that is immediately succeeding the wave point has an intensity lower than the wave point, and a first preceding wave point that is immediately preceding the wave point has an intensity higher than the wave point; and
the processing unit identifies the wave point as the critical point in a case that a first succeeding wave point that is immediately succeeding the wave point has an intensity lower than the wave point, and a first preceding wave point that is immediately preceding the wave point has an intensity lower than the wave point.

7. The radar system as claimed in claim 3, wherein, for each of the wave points included in the original waveform:
the processing unit categorizes the wave point as an upward point in a case that a first preceding wave point that is immediately preceding the wave point has an intensity lower than the wave point, and a second preceding wave point that is immediately preceding the first preceding wave point has an intensity lower than the first succeeding wave point;
the processing unit categorizes the wave point as a downward point in a case that a first preceding wave point that is immediately preceding the wave point has an intensity higher than the wave point, and a second preceding wave point that is immediately preceding the first preceding wave point has an intensity higher than the first succeeding wave point; and
the processing unit identifies the wave point as the critical point in a case that a first preceding wave point that is immediately preceding the wave point has an intensity higher than the wave point, and a second preceding wave point that is immediately preceding the first preceding wave point has an intensity lower than the first preceding wave point.

8. The radar system as claimed in claim 1, further comprising a transmitter that transmits a radio wave, and the received signal is an echo wave generated from the radio wave coming in contact with an object.

9. The radar system as claimed in claim 1, wherein:
the receiver receives a plurality of received signals each including an original waveform;
the processing unit, for each of the received signals, implements the procedure to process the original waveform so as to generate a corresponding adjusted waveform;
the processing unit further detects, based on the adjusted waveform for each of the received signals, an object, and determines a distance between the radar system and the object.

10. A method for adjusting a waveform, the method being implemented using a system that includes a receiver and a processing unit connected to the receiver, the method comprising:
receiving, by the receiver, a received signal that includes an original waveform, the original waveform including a plurality of discrete wave points that correspond respectively to successive time instances, each of the wave points indicating an intensity on a specific time instance; and
implementing, by the processing unit, a procedure to process the original waveform so as to generate an adjusted waveform, the procedure including, for each of the wave points,
determining whether the wave point is a critical point;
in response to determining that the wave point is a critical point, recording an intensity of the critical point, and setting the intensity of the critical point as a local high intensity; and
in response to determining that the wave point is not a critical point, adjusting the intensity of the wave point.

11. The method as claimed in claim 10, the original waveform of the received signal further including a starting point and an end point, a first angle being defined by a first line defined by the starting point and the critical point, a second line defined by the critical point and the end point, and the critical point at which the first line and the second line converge, wherein the procedure includes generating an adjusted waveform of the received signal to include a first part and a second part that converge at the critical point, and a second angle defined by the first part, the second part and the critical point is smaller than the first angle.

12. The method as claimed in claim 10, wherein the procedure further includes:
categorizing, for each of the wave points included in the original waveform excluding the critical point, the wave point into one of an upward point and a downward point.

13. The method as claimed in claim 12, wherein the adjusting of the intensity of each of the wave points that is not the critical point includes:
in the case that the wave point is an upward point, adjusting the wave point using an average intensity of the wave point and a plurality of preceding wave points; and
in the case that wave point is a downward point, adjusting the intensity of the wave point to zero.

14. The method as claimed in claim 12, wherein the categorizing of each of the wave points included in the original waveform excluding the critical point includes:
categorizing the wave point as an upward point in a case that a first succeeding wave point that is immediately succeeding the wave point has an intensity higher than the wave point, and a second succeeding wave point that is immediately succeeding the first succeeding wave point has an intensity higher than the first succeeding wave point;
categorizing the wave point as a downward point in a case that a first succeeding wave point that is immediately succeeding the wave point has an intensity lower than the wave point, and a second succeeding wave point that is immediately succeeding the first succeeding wave point has an intensity lower than the first succeeding wave point; and
identifying the wave point as the critical point in a case that a first succeeding wave point that is immediately succeeding the wave point has an intensity higher than the wave point, and a second succeeding wave point that is immediately succeeding the first succeeding wave point has an intensity lower than the first succeeding wave point.

15. The method as claimed in claim 12, wherein the categorizing of each of the wave points included in the original waveform excluding the critical point includes:
categorizing the wave point as an upward point in a case that a first succeeding wave point that is immediately succeeding the wave point has an intensity higher than the wave point, and a first preceding wave point that is immediately preceding the wave point has an intensity lower than the wave point;
categorizing the wave point as a downward point in a case that a first succeeding wave point that is immediately succeeding the wave point has an intensity lower than the wave point, and a first preceding wave point that is immediately preceding the wave point has an intensity higher than the wave point; and
identifying the wave point as the critical point in a case that a first succeeding wave point that is immediately succeeding the wave point has an intensity lower than the wave point, and a first preceding wave point that is immediately preceding the wave point has an intensity lower than the wave point.

16. The method as claimed in claim 12, wherein the categorizing of each of the wave points included in the original waveform excluding the critical point includes:
categorizing the wave point as an upward point in a case that a first preceding wave point that is immediately preceding the wave point has an intensity lower than the wave point, and a second preceding wave point that is immediately preceding the first preceding wave point has an intensity lower than the first succeeding wave point;
categorizing the wave point as a downward point in a case that a first preceding wave point that is immediately preceding the wave point has an intensity higher than the wave point, and a second preceding wave point that is immediately preceding the first preceding wave point has an intensity higher than the first succeeding wave point; and
identifying the wave point as the critical point in a case that a first preceding wave point that is immediately preceding the wave point has an intensity higher than the wave point, and a second preceding wave point that is immediately preceding the first preceding wave point has an intensity lower than the first preceding wave point.

17. The method as claimed in claim 10, the system further including a transmitter that transmits a radio wave, wherein the received signal is an echo wave generated from the radio wave coming in contact with an object.

18. The method as claimed in claim 10, wherein:
the receiver receives a plurality of received signals each including an original waveform;
the processing unit, for each of the received signals, implements the procedure to process the original waveform so as to generate a corresponding adjusted waveform;
the method further comprising the step of detecting, based on the adjusted waveform for each of the received signals, an object, and determines a distance between the radar system and the object.
